(19) United States
(12) Patent Application Publication
(10) Pub. No.: US 2025/0330617 A1
(43) Pub. Date: Oct. 23, 2025

(54) POSITION PREDICTION AND MATERIAL PROPERTY PREDICTION IN BASE MESH ENTROPY CODING

(71) Applicant: Samsung Electronics Co., Ltd., Suwon-si (KR)

(72) Inventors: Madhukar Budagavi, Plano, TX (US); Rajan Laxman Joshi, San Diego, CA (US)

(21) Appl. No.: 19/030,670

(22) Filed: Jan. 17, 2025

Related U.S. Application Data
(60) Provisional application No. 63/635,224, filed on Apr. 17, 2024.
(60) Provisional application No. 63/666,539, filed on Jul. 1, 2024.

(51) Int. Cl. H04N 19/167; H04N 19/17; H04N 19/70

(52) U.S. Cl. CPC H04N 19/167; H04N 19/17; H04N 19/70

(57) ABSTRACT

An apparatus directed to improvements to motion coding for vertices in an inter-coded base mesh frame is provided. The apparatus receives a compressed bitstream comprising a base mesh sub-bitstream and a syntax element. The apparatus decodes the syntax element to generate a prediction error. The apparatus decodes the base mesh sub-bitstream to generate a base mesh frame. The apparatus determines neighboring vertices of a vertex based on the base mesh frame. The apparatus determines a first predictor based on the neighbors of the vertex. The apparatus determines the vertex based on the first predictor and the prediction error.

### CROSS REFERENCE TO RELATED APPLICATION

This application claims benefit of U.S. Provisional Application No. 63/635,224 filed on Apr. 17, 2024, and U.S. Provisional Application No. 63/666,539 filed on Jul. 1, 2024, in the United States Patent and Trademark Office, the entire contents of which are hereby incorporated by reference.

### TECHNICAL FIELD

The disclosure relates to dynamic mesh coding, and more particularly to, for example, but not limited to, base-mesh entropy coding.

### BACKGROUND

Currently, International Organization for Standardization (ISO)/International Electrotechnical Commission (IEC) subcommittee 29 working group 07 (ISO/IEC SC29/WG07) is working on developing a standard for video-based compression of dynamic meshes. The seventh test model, V-DMC TMM 7.0, which represents the current status of the standard, was established in the 14th meeting of ISO/IEC SC29 WG07 in January 2024. Draft specification for video-based compression of dynamic meshes is also available.

In accordance with the seventh test model V-DMC TMM 7.0 and the corresponding working draft WD 6.0 (WD 6.0 of V-DMC, ISO/IEC SC29 WG07 N00822, January 2024), the V-DMC encoder produces a base mesh, which typically has less number of vertices compared to the original mesh, is created and compressed either in a lossy or lossless manner. The reconstructed base mesh undergoes subdivision and then a displacement field between the original mesh and the subdivided reconstructed base mesh is calculated. In inter coding of mesh frame, the base mesh is coded by sending vertex motions instead of compressing the base mesh directly.

The description set forth in the background section should not be assumed to be prior art merely because it is set forth in the background section. The background section may describe aspects or embodiments of the present disclosure.

### SUMMARY

This disclosure may be directed to improvements to dynamic mesh coding, more particularly to improvements to the position prediction and material property prediction in the base-mesh entropy encoding in V-DMC TMM 7.0 and the corresponding working draft WD 6.0.

An aspect of the disclosure provides an apparatus comprising a communication interface and a processor. The communication interface is configured to receive a compressed bitstream. The compressed bitstream comprises a base mesh sub-bitstream and a syntax element. The processor is operably coupled to the communication interface. The processor is configured to decode the syntax element to generate a first prediction error for a geometric coordinate of a current vertex. The processor is further configured to determine a geometric coordinate of a first neighboring vertex of the current vertex based on the base mesh sub-bitstream. The processor is further configured to determine a first predictor for the current vertex based on the geometric coordinate of the first neighboring vertex of the current vertex. The processor is further configured to determine a coordinate of the current vertex based on the first predictor and the first prediction error.

In some embodiments, the processor is further configured to determine a geometric coordinate of a second neighboring vertex of the current vertex based on the base mesh sub-bitstream. The processor is further configured to determine the first predictor for the current vertex based on the geometric coordinate of the first neighboring vertex of the current vertex and the geometric coordinate of the second neighboring vertex of the current vertex.

In some embodiments, the processor is further configured to determine a geometric coordinate of a second neighboring vertex of the current vertex based on the base mesh sub-bitstream. The processor is further configured to determine a second predictor based on the geometric coordinate of the second neighboring vertex. The current vertex comprises determining a final predictor based on the first predictor and the second predictor. The current vertex further comprises determining the current vertex based on the final predictor and the first prediction error.

In some embodiments, the final predictor is determined by applying a first predetermined weight to the first predictor and applying a second predetermined weight to the second predictor.

In some embodiments, the first and second predetermined weights have values so that the final predictor is a weighted average of the first predictor and the second predictor.

In some embodiments, the processor is further configured to determine a second prediction error for a texture coordinate of the current vertex. The processor is further configured to determine a texture coordinate of the first neighboring vertex. The processor is further configured to determine a predictor for the texture coordinate of the current vertex based on the texture coordinate of the first neighboring vertex. The processor is further configured to determine the texture coordinate for the current vertex based on the predictor for the texture coordinate of the current vertex and the second prediction error for the texture coordinate of the current vertex.

In some embodiments, the processor is further configured to determine a texture coordinate of a second neighboring vertex. The processor is further configured to determine a predictor for the texture coordinate of the current vertex based on the texture coordinate of the first neighboring vertex and the texture coordinate of the second neighboring vertex.

In some embodiments, the predictor for the texture coordinate of the current vertex is determined based on the texture coordinate of the first neighboring vertex, the geometric coordinate of the first neighboring vertex, and the geometric coordinate of the current vertex.

An aspect of the disclosure provides a method. The method comprises receiving a compressed bitstream comprising a base mesh sub-bitstream and a syntax element. The method further comprises decoding the syntax element to generate a first prediction error for a geometric coordinate of a current vertex. The method further comprises determining a geometric coordinate of a first neighboring vertex of the current vertex based on the base mesh sub-bitstream. The method further comprises determining a first predictor for the current vertex based on the geometric coordinate of the first neighboring vertex of the current vertex. The method further comprises determining a geometric coordinate of the current vertex based on the first predictor and the first prediction error.

In some embodiments, the method further comprises determining a geometric coordinate of a second neighboring vertex of the current vertex based on the base mesh sub-bitstream. The method further comprises determining the first predictor for the current vertex based on the geometric coordinate of the first neighboring vertex of the current vertex and the geometric coordinate of the second neighboring vertex of the current vertex.

In some embodiments, the method further comprises determining a geometric coordinate of a second neighboring vertex of the current vertex based on the base mesh sub-bitstream. The method further comprises determining a second predictor based on the geometric coordinate of the second neighboring vertex. The current vertex comprises determining a final predictor based on the first predictor and the second predictor. The current vertex further comprises determining the current vertex based on the final predictor and the first prediction error.

In some embodiments, the final predictor is determined by applying a first predetermined weight to the first predictor and applying a second predetermined weight to the second predictor.

In some embodiments, the first and second predetermined weights have values so that the final predictor is a weighted average of the first predictor and the second predictor.

In some embodiments, the method further comprises determining a second prediction error for a texture coordinate of the current vertex. The method further comprises determining a texture coordinate of the first neighboring vertex. The method further comprises determining a predictor for the texture coordinate of the current vertex based on the texture coordinate of the first neighboring vertex. The method further comprises determining the texture coordinate for the current vertex based on the predictor for the texture coordinate of the current vertex and the second prediction error for the texture coordinate of the current vertex.

In some embodiments, the method further comprises determining a texture coordinate of a second neighboring vertex. The method further comprises determining a predictor for the texture coordinate of the current vertex based on the texture coordinate of the first neighboring vertex and the texture coordinate of the second neighboring vertex.

In some embodiments, the predictor for the texture coordinate of the current vertex is determined based on the texture coordinate of the first neighboring vertex, the geometric coordinate of the first neighboring vertex, and the geometric coordinate of the current vertex.

An aspect of the disclosure provides an apparatus comprising a communication interface and a processor. The processor is operably coupled to the communication interface. The processor is configured to determine a first vertex on a mesh frame. The processor is further configured to determine a geometric coordinate of a first neighboring vertex of the first vertex. The processor is further configured to generate a predictor based on the geometric coordinate of the first neighboring vertex. The processor is further configured to determine a first prediction error based on the first vertex and the predictor. The processor is further configured to generate a base mesh frame based on the mesh frame. The processor is further configured to encode the base mesh frame and the first prediction error to generate a compressed bitstream. The processor is further configured to transmit the compressed bitstream.

In some embodiments, the processor is further configured to determine a geometric coordinate of a second neighboring vertex of the first vertex. The processor is further configured to generate a predictor based on the geometric coordinate of the first neighboring vertex and the geometric coordinate of the second neighboring vertex.

In some embodiments, the processor is further configured to determine a texture coordinate for the first vertex. The processor is further configured to determine a texture coordinate of the first neighboring vertex. The processor is further configured to generate a texture coordinate for a predictor based on the texture coordinate of the first neighboring vertex. The processor is further configured to determine a second prediction error based on the texture coordinates of the first vertex and the texture coordinates of the predictor. The processor is further configured to encode the base mesh frame and the second prediction error to generate a compressed bitstream. The processor is further configured to transmit the compressed bitstream.

In some embodiments, the processor is further configured to determine a texture coordinate of a second neighboring vertex. The processor is further configured to generate a texture coordinate for a predictor based on the texture coordinate of the first neighboring vertex and the texture coordinate of the second neighboring vertex.

This improvement provides simplification of the prediction process in dynamic mesh coding because it uses 7 or 8 bits rather than 32-bit or 64-bit floating point numbers reducing the processes required. Additionally, there is a need for a standard which will output the same across platforms and this improvement generates the same results on each platform.

### BRIEF DESCRIPTION OF THE DRAWINGS

FIG. 1 illustrates an example communication system 100 in accordance with an embodiment of this disclosure.

FIGS. 2 and 3 illustrate example electronic devices in accordance with an embodiment of this disclosure.

FIG. 4 illustrates a block diagram for an encoder encoding intra frames in accordance with an embodiment.

FIG. 5 illustrates a block diagram for a decoder in accordance with an embodiment.

FIG. 6 shows the basic block diagram of a V-DMC encoder in accordance with an embodiment.

FIG. 7 shows the basic block diagram of a V-DMC decoder in accordance with an embodiment.

FIG. 8 shows an example of a parallelogram predictor.

FIG. 9 shows an example of a multiple parallelogram predictor.

FIG. 10 is a flowchart showing operations of the base mesh encoder for geometry coordinate prediction in accordance with an embodiment.

FIG. 11 is a flowchart showing operations of the base mesh decoder for geometry coordinate prediction in accordance with an embodiment.

FIG. 12 is a flowchart showing operations of the base mesh encoder for texture coordinate prediction in accordance with an embodiment.

FIG. 13 is a flowchart showing operations of the base mesh decoder for texture coordinate prediction in accordance with an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

Three hundred sixty degree (360°) video and 3D volumetric video are emerging as new ways of experiencing immersive content due to the ready availability of powerful handheld devices such as smartphones. While 360° video enables immersive “real life,” “being there” experience for consumers by capturing the 360° outside-in view of the world, 3D volumetric video can provide complete 6DoF experience of being and moving within the content. Users can interactively change their viewpoint and dynamically view any part of the captured scene or object they desire. Display and navigation sensors can track head movement of the user in real-time to determine the region of the 360° video or volumetric content that the user wants to view or interact with. Multimedia data that is three-dimensional (3D) in nature, such as point clouds or 3D polygonal meshes, can be used in the immersive environment.

A point cloud is a set of 3D points along with attributes such as color, normal, reflectivity, point-size, etc. that represent an object's surface or volume. Point clouds are common in a variety of applications such as gaming, 3D maps, visualizations, medical applications, augmented reality, virtual reality, autonomous driving, multi-view replay, 6DoF immersive media, to name a few. Point clouds, if uncompressed, generally require a large amount of bandwidth for transmission. Due to the large bitrate requirement, point clouds are often compressed prior to transmission. To compress a 3D object such as a point cloud, often requires specialized hardware. To avoid specialized hardware to compress a 3D point cloud, a 3D point cloud can be transformed into traditional two-dimensional (2D) frames and that can be compressed and later be reconstructed and viewable to a user.

Polygonal 3D meshes, especially triangular meshes, are another popular format for representing 3D objects. Meshes typically consist of a set of vertices, edges and faces that are used for representing the surface of 3D objects. Triangular meshes are simple polygonal meshes in which the faces are simple triangles covering the surface of the 3D object. Typically, there may be one or more attributes associated with the mesh. In one scenario, one or more attributes may be associated with each vertex in the mesh. For example, a texture attribute (RGB) may be associated with each vertex. In another scenario, each vertex may be associated with a pair of coordinates, (u, v). The (u, v) coordinates may point to a position in a texture map associated with the mesh. For example, the (u, v) coordinates may refer to row and column indices in the texture map, respectively. A mesh can be thought of as a point cloud with additional connectivity information.

The point cloud or meshes may be dynamic, i.e., they may vary with time. In these cases, the point cloud or mesh at a particular time instant may be referred to as a point cloud frame or a mesh frame, respectively.

Since point clouds and meshes contain a large amount of data, they require compression for efficient storage and transmission. This is particularly true for dynamic point clouds and meshes, which may contain 60 frames or higher per second.

Figures discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably-arranged system or device.

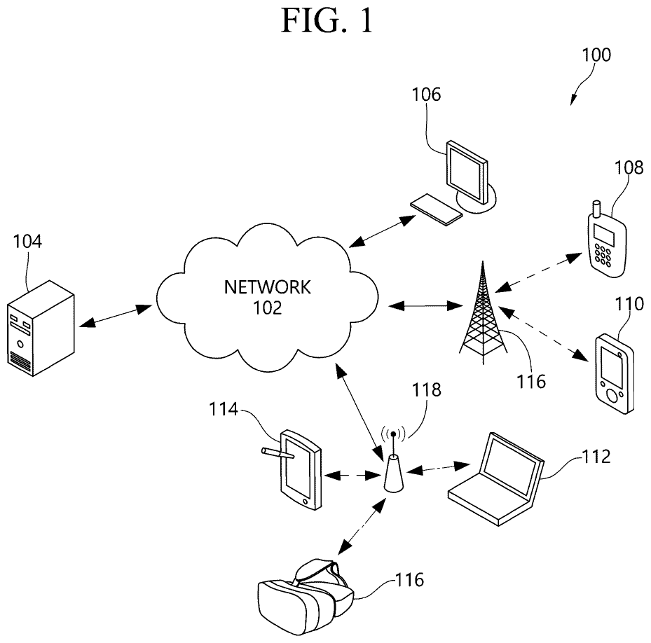

FIG. 1 illustrates an example communication system 100 in accordance with an embodiment of this disclosure. The embodiment of the communication system 100 shown in FIG. 1 is for illustration only. Other embodiments of the communication system 100 can be used without departing from the scope of this disclosure.

The communication system 100 includes a network 102 that facilitates communication between various components in the communication system 100. For example, the network 102 can communicate IP packets, frame relay frames, Asynchronous Transfer Mode (ATM) cells, or other information between network addresses. The network 102 includes one or more local area networks (LANs), metropolitan area networks (MANs), wide area networks (WANs), all or a portion of a global network such as the Internet, or any other communication system or systems at one or more locations.

In this example, the network 102 facilitates communications between a server 104 and various client devices 106-116. The client devices 106-116 may be, for example, a smartphone, a tablet computer, a laptop, a personal computer, a TV, an interactive display, a wearable device, a HMD, or the like. The server 104 can represent one or more servers. Each server 104 includes any suitable computing or processing device that can provide computing services for one or more client devices, such as the client devices 106-116. Each server 104 could, for example, include one or more processing devices, one or more memories storing instructions and data, and one or more network interfaces facilitating communication over the network 102. As described in more detail below, the server 104 can transmit a compressed bitstream, representing a point cloud or mesh, to one or more display devices, such as a client device 106-116. In certain embodiments, each server 104 can include an encoder.

Each client device 106-116 represents any suitable computing or processing device that interacts with at least one server (such as the server 104) or other computing device(s) over the network 102. The client devices 106-116 include a desktop computer 106, a mobile telephone or mobile device 108 (such as a smartphone), a PDA 110, a laptop computer 112, a tablet computer 114, and a HMD 116. However, any other or additional client devices could be used in the communication system 100. Smartphones represent a class of mobile devices 108 that are handheld devices with mobile operating systems and integrated mobile broadband cellular network connections for voice, short message service (SMS), and Internet data communications. The HMD 116 can display 360° scenes including one or more dynamic or static 3D point clouds. In certain embodiments, any of the client devices 106-116 can include an encoder, decoder, or both. For example, the mobile device 108 can record a 3D volumetric video and then encode the video enabling the video to be transmitted to one of the client devices 106-116. In another example, the laptop computer 112 can be used to generate a 3D point cloud or mesh, which is then encoded and transmitted to one of the client devices 106-116.

In this example, some client devices 108-116 communicate indirectly with the network 102. For example, the mobile device 108 and PDA 110 communicate via one or more base stations 118, such as cellular base stations or eNodeBs (eNBs). Also, the laptop computer 112, the tablet computer 114, and the HMD 116 communicate via one or more wireless access points 120, such as IEEE 802.11 wireless access points. Note that these are for illustration only and that each client device 106-116 could communicate directly with the network 102 or indirectly with the network 102 via any suitable intermediate device(s) or network(s). In certain embodiments, the server 104 or any client device 106-116 can be used to compress a point cloud or mesh, generate a bitstream that represents the point cloud or mesh, and transmit the bitstream to another client device such as any client device 106-116.

In certain embodiments, any of the client devices 106-114 transmit information securely and efficiently to another device, such as, for example, the server 104. Also, any of the client devices 106-116 can trigger the information transmission between itself and the server 104. Any of the client devices 106-114 can function as a VR display when attached to a headset via brackets, and function similar to HMD 116. For example, the mobile device 108 when attached to a bracket system and worn over the eyes of a user can function similarly as the HMD 116. The mobile device 108 (or any other client device 106-116) can trigger the information transmission between itself and the server 104.

In certain embodiments, any of the client devices 106-116 or the server 104 can create a 3D point cloud or mesh, compress a 3D point cloud or mesh, transmit a 3D point cloud or mesh, receive a 3D point cloud or mesh, decode a 3D point cloud or mesh, render a 3D point cloud or mesh, or a combination thereof. For example, the server 104 can then compress 3D point cloud or mesh to generate a bitstream and then transmit the bitstream to one or more of the client devices 106-116. For another example, one of the client devices 106-116 can compress a 3D point cloud or mesh to generate a bitstream and then transmit the bitstream to another one of the client devices 106-116 or to the server 104.

Although FIG. 1 illustrates one example of a communication system 100, various changes can be made to FIG. 1. For example, the communication system 100 could include any number of each component in any suitable arrangement. In general, computing and communication systems come in a wide variety of configurations, and FIG. 1 does not limit the scope of this disclosure to any particular configuration. While FIG. 1 illustrates one operational environment in which various features disclosed in this patent document can be used, these features could be used in any other suitable system.

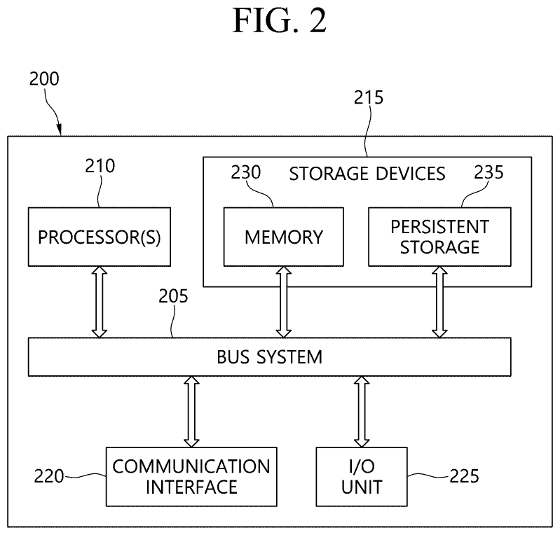

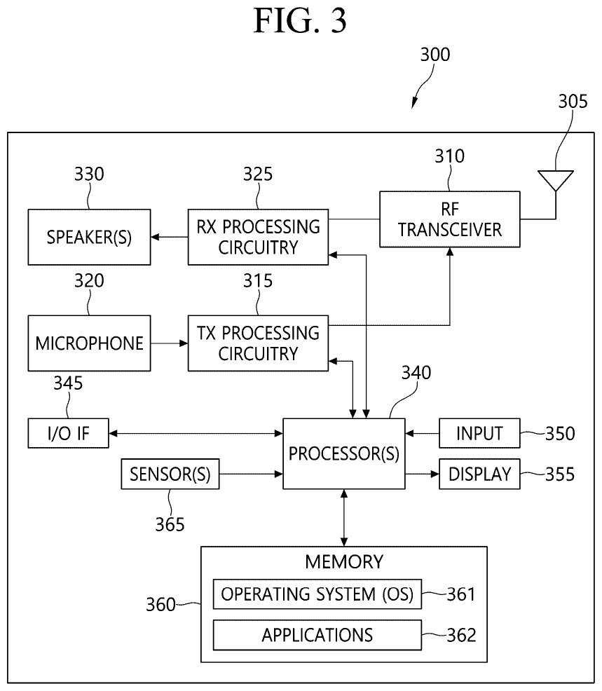

FIGS. 2 and 3 illustrate example electronic devices in accordance with an embodiment of this disclosure. In particular, FIG. 2 illustrates an example server 200, and the server 200 could represent the server 104 in FIG. 1. The server 200 can represent one or more encoders, decoders, local servers, remote servers, clustered computers, and components that act as a single pool of seamless resources, a cloud-based server, and the like. The server 200 can be accessed by one or more of the client devices 106-116 of FIG. 1 or another server.

The server 200 can represent one or more local servers, one or more compression servers, or one or more encoding servers, such as an encoder. In certain embodiments, the encoder can perform decoding. As shown in FIG. 2, the server 200 includes a bus system 205 that supports communication between at least one processing device (such as a processor 210), at least one storage device 215, at least one communications interface 220, and at least one input/output (I/O) unit 225.

The processor 210 executes instructions that can be stored in a memory 230. The processor 210 can include any suitable number(s) and type(s) of processors or other devices in any suitable arrangement. Example types of processors 210 include microprocessors, microcontrollers, digital signal processors, field programmable gate arrays, application specific integrated circuits, and discrete circuitry.

In certain embodiments, the processor 210 can encode a 3D point cloud or mesh stored within the storage devices 215. In certain embodiments, encoding a 3D point cloud also decodes the 3D point cloud or mesh to ensure that when the point cloud or mesh is reconstructed, the reconstructed 3D point cloud or mesh matches the 3D point cloud or mesh prior to the encoding.

The memory 230 and a persistent storage 235 are examples of storage devices 215 that represent any structure(s) capable of storing and facilitating retrieval of information (such as data, program code, or other suitable information on a temporary or permanent basis). The memory 230 can represent a random access memory or any other suitable volatile or non-volatile storage device(s). For example, the instructions stored in the memory 230 can include instructions for decomposing a point cloud into patches, instructions for packing the patches on 2D frames, instructions for compressing the 2D frames, as well as instructions for encoding 2D frames in a certain order in order to generate a bitstream. The instructions stored in the memory 230 can also include instructions for rendering the point cloud on an omnidirectional 360° scene, as viewed through a VR headset, such as HMD 116 of FIG. 1. The persistent storage 235 can contain one or more components or devices supporting longer-term storage of data, such as a read only memory, hard drive, Flash memory, or optical disc.

The communications interface 220 supports communications with other systems or devices. For example, the communications interface 220 could include a network interface card or a wireless transceiver facilitating communications over the network 102 of FIG. 1. The communications interface 220 can support communications through any suitable physical or wireless communication link(s). For example, the communications interface 220 can transmit a bitstream containing a 3D point cloud or a mesh to another device such as one of the client devices 106-116.

The I/O unit 225 allows for input and output of data. For example, the I/O unit 225 can provide a connection for user input through a keyboard, mouse, keypad, touchscreen, or other suitable input device. The I/O unit 225 can also send output to a display, printer, or other suitable output device. Note, however, that the I/O unit 225 can be omitted, such as when I/O interactions with the server 200 occur via a network connection.

Note that while FIG. 2 is described as representing the server 104 of FIG. 1, the same or similar structure could be used in one or more of the various client devices 106-116. For example, a desktop computer 106 or a laptop computer 112 could have the same or similar structure as that shown in FIG. 2.

FIG. 3 illustrates an example electronic device 300, and the electronic device 300 could represent one or more of the client devices 106-116 in FIG. 1. The electronic device 300 can be a mobile communication device, such as, for example, a mobile station, a subscriber station, a wireless terminal, a desktop computer (similar to the desktop computer 106 of FIG. 1), a portable electronic device (similar to the mobile device 108, the PDA 110, the laptop computer 112, the tablet computer 114, or the HMD 116 of FIG. 1), and the like. In certain embodiments, one or more of the client devices 106-116 of FIG. 1 can include the same or similar configuration as the electronic device 300. In certain embodiments, the electronic device 300 is an encoder, a decoder, or both. For example, the electronic device 300 is usable with data transfer, image or video compression, image or video decompression, encoding, decoding, and media rendering applications.

As shown in FIG. 3, the electronic device 300 includes an antenna 305, a radio-frequency (RF) transceiver 310, transmit (TX) processing circuitry 315, a microphone 320, and receive (RX) processing circuitry 325. The RF transceiver 310 can include, for example, a RF transceiver, a BLUETOOTH transceiver, a WI-FI transceiver, a ZIGBEE transceiver, an infrared transceiver, and various other wireless communication signals. The electronic device 300 also includes a speaker 330, a processor 340, an input/output (I/O) interface (IF) 345, an input 350, a display 355, a memory 360, and a sensor(s) 365. The memory 360 includes an operating system (OS) 361, and one or more applications 362.

The RF transceiver 310 receives, from the antenna 305, an incoming RF signal transmitted from an access point (such as a base station, WI-FI router, or BLUETOOTH device) or other device of the network 102 (such as a WI-FI, BLUETOOTH, cellular, 5G, LTE, LTE-A, WiMAX, or any other type of wireless network). The RF transceiver 310 down-converts the incoming RF signal to generate an intermediate frequency or baseband signal. The intermediate frequency or baseband signal is sent to the RX processing circuitry 325 that generates a processed baseband signal by filtering, decoding, and/or digitizing the baseband or intermediate frequency signal. The RX processing circuitry 325 transmits the processed baseband signal to the speaker 330 (such as for voice data) or to the processor 340 for further processing (such as for web browsing data).

The TX processing circuitry 315 receives analog or digital voice data from the microphone 320 or other outgoing baseband data from the processor 340. The outgoing baseband data can include web data, e-mail, or interactive video game data. The TX processing circuitry 315 encodes, multiplexes, and/or digitizes the outgoing baseband data to generate a processed baseband or intermediate frequency signal. The RF transceiver 310 receives the outgoing processed baseband or intermediate frequency signal from the TX processing circuitry 315 and up-converts the baseband or intermediate frequency signal to an RF signal that is transmitted via the antenna 305.

The processor 340 can include one or more processors or other processing devices. The processor 340 can execute instructions that are stored in the memory 360, such as the OS 361 in order to control the overall operation of the electronic device 300. For example, the processor 340 could control the reception of forward channel signals and the transmission of reverse channel signals by the RF transceiver 310, the RX processing circuitry 325, and the TX processing circuitry 315 in accordance with well-known principles. The processor 340 can include any suitable number(s) and type(s) of processors or other devices in any suitable arrangement. For example, in certain embodiments, the processor 340 includes at least one microprocessor or microcontroller. Example types of processor 340 include microprocessors, microcontrollers, digital signal processors, field programmable gate arrays, application specific integrated circuits, and discrete circuitry.

The processor 340 is also capable of executing other processes and programs resident in the memory 360, such as operations that receive and store data. The processor 340 can move data into or out of the memory 360 as required by an executing process. In certain embodiments, the processor 340 is configured to execute the one or more applications 362 based on the OS 361 or in response to signals received from external source(s) or an operator. Example, applications 362 can include an encoder, a decoder, a VR or AR application, a camera application (for still images and videos), a video phone call application, an email client, a social media client, a SMS messaging client, a virtual assistant, and the like. In certain embodiments, the processor 340 is configured to receive and transmit media content.

The processor 340 is also coupled to the I/O interface 345 that provides the electronic device 300 with the ability to connect to other devices, such as client devices 106-114. The I/O interface 345 is the communication path between these accessories and the processor 340.

The processor 340 is also coupled to the input 350 and the display 355. The operator of the electronic device 300 can use the input 350 to enter data or inputs into the electronic device 300. The input 350 can be a keyboard, touchscreen, mouse, track ball, voice input, or other device capable of acting as a user interface to allow a user in interact with the electronic device 300. For example, the input 350 can include voice recognition processing, thereby allowing a user to input a voice command. In another example, the input 350 can include a touch panel, a (digital) pen sensor, a key, or an ultrasonic input device. The touch panel can recognize, for example, a touch input in at least one scheme, such as a capacitive scheme, a pressure sensitive scheme, an infrared scheme, or an ultrasonic scheme. The input 350 can be associated with the sensor(s) 365 and/or a camera by providing additional input to the processor 340. In certain embodiments, the sensor 365 includes one or more inertial measurement units (IMUs) (such as accelerometers, gyroscope, and magnetometer), motion sensors, optical sensors, cameras, pressure sensors, heart rate sensors, altimeter, and the like. The input 350 can also include a control circuit. In the capacitive scheme, the input 350 can recognize touch or proximity.

The display 355 can be a liquid crystal display (LCD), light-emitting diode (LED) display, organic LED (OLED), active matrix OLED (AMOLED), or other display capable of rendering text and/or graphics, such as from websites, videos, games, images, and the like. The display 355 can be sized to fit within a HMD. The display 355 can be a singular display screen or multiple display screens capable of creating a stereoscopic display. In certain embodiments, the display 355 is a heads-up display (HUD). The display 355 can display 3D objects, such as a 3D point cloud or mesh.

The memory 360 is coupled to the processor 340. Part of the memory 360 could include a RAM, and another part of the memory 360 could include a Flash memory or other ROM. The memory 360 can include persistent storage (not shown) that represents any structure(s) capable of storing and facilitating retrieval of information (such as data, program code, and/or other suitable information). The memory 360 can contain one or more components or devices supporting longer-term storage of data, such as a read only memory, hard drive, Flash memory, or optical disc. The memory 360 also can contain media content. The media content can include various types of media such as images, videos, three-dimensional content, VR content, AR content, 3D point clouds, meshes, and the like.

The electronic device 300 further includes one or more sensors 365 that can meter a physical quantity or detect an activation state of the electronic device 300 and convert metered or detected information into an electrical signal. For example, the sensor 365 can include one or more buttons for touch input, a camera, a gesture sensor, an IMU sensors (such as a gyroscope or gyro sensor and an accelerometer), an eye tracking sensor, an air pressure sensor, a magnetic sensor or magnetometer, a grip sensor, a proximity sensor, a color sensor, a bio-physical sensor, a temperature/humidity sensor, an illumination sensor, an Ultraviolet (UV) sensor, an Electromyography (EMG) sensor, an Electroencephalogram (EEG) sensor, an Electrocardiogram (ECG) sensor, an IR sensor, an ultrasound sensor, an iris sensor, a fingerprint sensor, a color sensor (such as a Red Green Blue (RGB) sensor), and the like. The sensor 365 can further include control circuits for controlling any of the sensors included therein.

As discussed in greater detail below, one or more of these sensor(s) 365 may be used to control a user interface (UI), detect UI inputs, determine the orientation and facing the direction of the user for three-dimensional content display identification, and the like. Any of these sensor(s) 365 may be located within the electronic device 300, within a secondary device operably connected to the electronic device 300, within a headset configured to hold the electronic device 300, or in a singular device where the electronic device 300 includes a headset.

The electronic device 300 can create media content such as generate a virtual object or capture (or record) content through a camera. The electronic device 300 can encode the media content to generate a bitstream, such that the bitstream can be transmitted directly to another electronic device or indirectly such as through the network 102 of FIG. 1. The electronic device 300 can receive a bitstream directly from another electronic device or indirectly such as through the network 102 of FIG. 1.

Although FIGS. 2 and 3 illustrate examples of electronic devices, various changes can be made to FIGS. 2 and 3. For example, various components in FIGS. 2 and 3 could be combined, further subdivided, or omitted and additional components could be added according to particular needs. As a particular example, the processor 340 could be divided into multiple processors, such as one or more central processing units (CPUs) and one or more graphics processing units (GPUs). In addition, as with computing and communication, electronic devices and servers can come in a wide variety of configurations, and FIGS. 2 and 3 do not limit this disclosure to any particular electronic device or server.

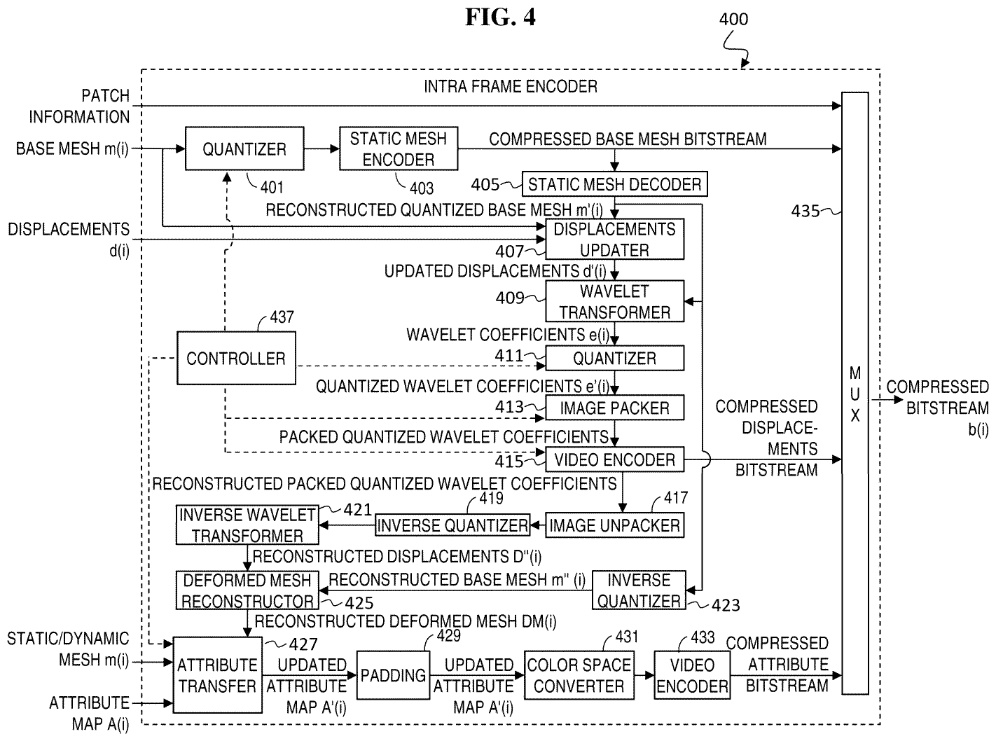

FIG. 4 illustrates a block diagram for an encoder encoding intra frames in accordance with an embodiment.

As shown in FIG. 4, the encoder 400 encoding intra frames in accordance with an embodiment may comprise a quantizer 401, a static mesh encoder 403, a static mesh decoder 405, a displacements updater 407, a wavelet transformer 409, a quantizer 411, an image packer 413, a video encoder 415, an image unpacker 417, an inverse quantizer 419, an inverse wavelet transformer 421, an inverse quantizer 423, a deformed mesh reconstructor 425, an attribute transfer module 427, a padding module 429, a color space converter 431, a video encoder 433, a multiplexer 435, and a controller 437.

The quantizer 401 may quantize a base mesh m(i) to generate a quantized base mesh. In some embodiments, the base mesh may have fewer vertices compared to an original mesh.

The static mesh encoder 403 may encode and compress the quantized base mesh to generate a compressed base mesh bitstream. In some embodiments, the base mesh may be compressed in a lossy or lossless manner. In some embodiments, an already existing mesh codec such as Draco may be used to compress the base mesh.

The static mesh decoder 405 may decode the compressed base mesh bitstream to generate a reconstructed quantized base mesh m′(i).

The displacements updater 407 may update displacements d(i) based on the base mesh m(i) after subdivision and the reconstructed quantized base mesh m′(i) to generate updated displacements d′(i). The reconstructed base mesh may undergo subdivision and then a displacement field between the original mesh and the subdivided reconstructed base mesh may be determined. In inter coding of mesh frame, the base mesh may be coded by sending vertex motions instead of compressing the base mesh directly. In either case, a displacement field may be created. The displacement field as well as the modified attribute map may be coded using a video codec and also included as a part of the V-DMC bitstream.

The wavelet transformer 409 may perform a wavelet transform with the updated displacements d′(i) to generate displacement wavelet coefficients e(i). The wavelet transform may comprise a series of prediction and update lifting steps.

The quantizer 411 may quantize the displacement wavelet coefficients e(i) to generate quantized displacement wavelet coefficients e′(i). The quantized displacement wavelet coefficients may be denoted by an array dispQuantCoeffArray.

The image packer 413 may pack the quantized displacement wavelet coefficients e′(i) into a 2D image including packed quantized displacement wavelet coefficients dispQuantCoeffFrame. The 2D video frame may be referred to as a displacement frame or a displacement video frame in this disclosure.

The video encoder 415 may encode the packed quantized displacement wavelet coefficients dispQuantCoeffFrame to generate a compressed displacements bitstream.

The image unpacker 417 may unpack the packed quantized displacement wavelet coefficients dispQuantCoeffFrame to generate an array dispQuantCoeffArray of quantized displacement wavelet coefficients.

The inverse quantizer 419 may inversely quantize the array dispQuantCoeffArray of quantized displacement wavelet coefficients to generate displacement wavelet coefficients.

The inverse wavelet transformer 421 may perform an inverse wavelet transform with the displacement wavelet coefficients to generate reconstructed displacements d″(i).

The inverse quantizer 423 may inversely quantize the reconstructed quantized base mesh m′(i) to generate a reconstructed base mesh m″(i).

The deformed mesh reconstructor 425 may generate a reconstruct deformed mesh DM(i) based on the reconstructed displacements D″(i) and a reconstructed base mesh m″(i).

The attribute transfer module 427 may update an attribute map A(i) based on a static/dymanic mesh m(i) and a reconstructed deformed mesh DM(i) to generate an updated attribute map A′(i). The attribute map may be a texture map but other attributes may be sent as well.

The padding module 429 may perform padding to fill empty areas in the updated attribute map A′(i) so as to remove high frequency components.

The color space converter 431 may perform a color space conversion of the padded updated attribute map A′(i).

The video encoder 433 may encode the output of the color space converter 431 to generate the compressed attribute bitstream.

The multiplexer 435 may multiplex the compressed base mesh bitstream, the compressed displacements bitstream, and the compressed attribute bitstream to generate a compressed bitstream b(i).

The controller 437 may control modules of the encoder 400.

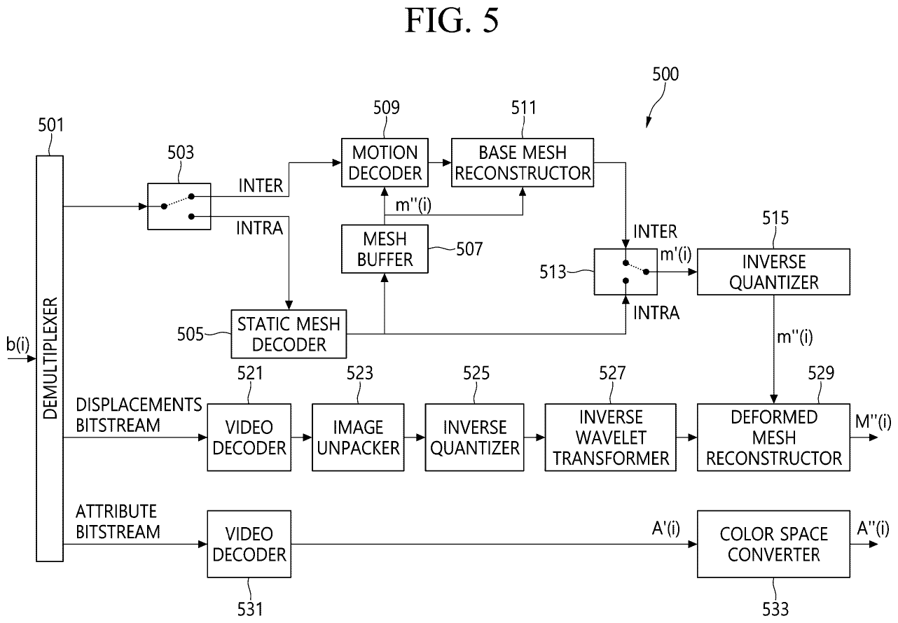

FIG. 5 illustrates a block diagram for a decoder in accordance with an embodiment.

As shown in FIG. 5, the decoder 500 may comprise a demultiplexer 501, a switch 503, a static mesh decoder 505, a mesh buffer 507, a motion decoder 509, a base mesh reconstructor 511, a switch 513, an inverse quantizer 515, a video decoder 521, an image unpacker 523, an inverse quantizer 525, an inverse wavelet transformer 527, a deformed mesh reconstructor 529, a video decoder 531, and a color space converter 533.

The demultiplexer 501 may receive the compressed bitstream b(i) from the encoder 400 to extract the compressed base mesh bitstream, the compressed displacements bitstream, and the compressed attribute bitstream from the compressed bitstream b(i).

The switch 503 may determine whether the compressed base mesh bitstream has an inter-coded mesh frame or an intra-coded mesh frame. If the compressed base mesh bitstream has the inter-coded mesh frame, the switch 503 may transfer the inter-coded mesh frame to the motion decoder 509. If the compressed base mesh bitstream has the intra-coded mesh frame, the switch 503 may transfer the intra-coded mesh frame to the static mesh decoder 505.

The static mesh decoder 505 may decode the intra-coded mesh frame to generate a reconstructed quantized base mesh frame.

The mesh buffer 507 may store the reconstructed quantized base mesh frames and the inter-coded mesh frame for future use of decoding subsequent inter-coded mesh frames. The reconstructed quantized base mesh frames may be used as reference mesh frames.

The motion decoder 509 may obtain motion vectors for a current inter-coded mesh frame based on data stored in the mesh buffer 507 and syntax elements in the bitstream for the current inter-coded mesh frame. In some embodiments, the syntax elements in the bitstream for the current inter-coded mesh frame may be a motion vector difference.

The base mesh reconstructor 511 may generate a reconstructed quantized base mesh frame by using syntax elements in the bitstream for the current inter-coded mesh frame based on the motion vectors for the current inter-coded mesh frame.

The switch 513 may transmit the reconstructed quantized base mesh frame from the static mesh decoder 505 to the inverse quantizer 515, if the compressed base mesh bitstream has the intra-coded mesh frame. The switch 513 may transmit the reconstructed quantized base mesh frame from the static mesh decoder 511 to the inverse quantizer 515, if the compressed base mesh bitstream has the inter-coded mesh frame.

The inverse quantizer 515 may perform an inverse quantization with the reconstructed quantized base mesh frame to generate a reconstructed base mesh frame m″(i).

The video decoder 521 may decode a displacements bitstream to generate packed quantized displacement wavelet coefficients dispQuantCoeffFrame.

The image unpacker 523 may unpack the packed quantized displacement wavelet coefficients dispQuantCoeffFrame to generate an array dispQuantCoeffArray of quantized displacement wavelet coefficients.

The inverse quantizer 525 may perform the inverse quantization with the array dispQuantCoeffArray of quantized displacement wavelet coefficients to generate displacement wavelet coefficients.

The inverse wavelet transformer 527 may perform the inverse wavelet transform with displacement wavelet coefficients to generate displacements.

The deformed mesh reconstructor 529 may reconstruct a deformed mesh based on the displacements and the reconstructed base mesh frame m″(i).

The video decoder 531 may decode the attribute bitstream to generate an attribute map before a color space conversion.

The color space converter 533 may perform a color space conversion of the attribute map from the video decoder 531 to reconstruct the attribute map.

The following documents are hereby incorporated by reference in their entirety into the present disclosure as if fully set forth herein: i) V-DMC TMM 7.0, ISO/IEC SC29 WG07 N00811, January 2024, ii) “WD 6.0 of V-DMC”, ISO/IEC SC29 WG07 N00822, January 2024.

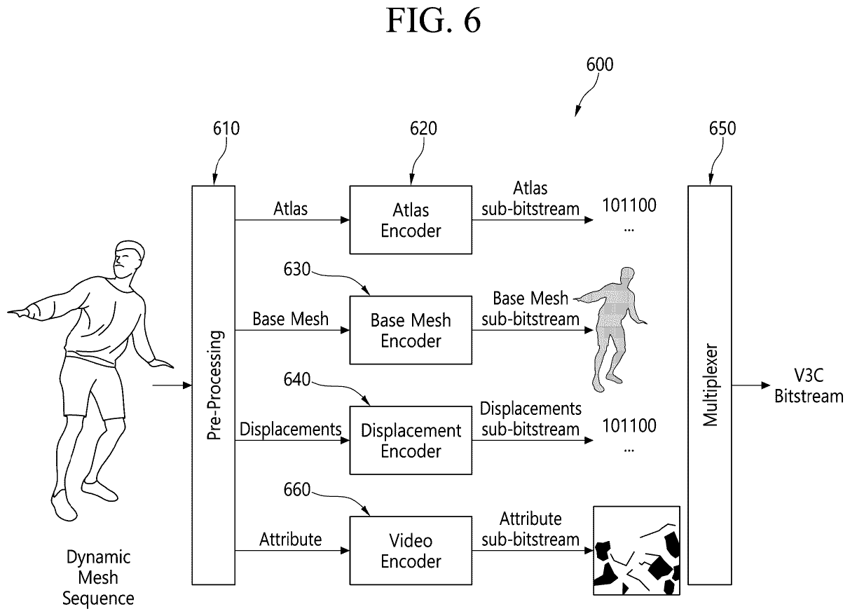

FIG. 6 shows a basic block diagram for V-DMC encoder in accordance with an embodiment.

Referring to FIG. 6, the V-DMC encoder 600 in accordance with an embodiment includes pre-processing unit 610, an atlas encoder 620, a base mesh encoder 630, a displacement encoder 640, and a multiplexer 650. In some embodiments, the V-DMC encoder 600 may include a video encoder 660.

The pre-processing unit 610 may process the dynamic mesh sequence to generate atlas information, base mesh m(i), and displacement d(i). In some embodiments, the pre-processing unit 610 may further process the dynamic mesh sequence to additionally generate attribute A(i). The atlas encoder 620 may encode the atlas information to generate an atlas sub-bitstream. The base mesh encoder 630 may encode the base mesh m(i) to generate a base mesh sub-bitstream. The displacement encoder 640 may encode the displacement d(i) to generate a displacements sub-bitstream. In some embodiments, the video encoder 660 may encode the attribute A(i) to generate an attribute sub-bitstream. The multiplexer 650 may combine the atlas sub-bitstream, base mesh sub-bitstream and the displacements sub-bitstream to generate a single V3C Bitstream b(i). In some embodiments, the multiplexer 650 may combine the atlas sub-bitstream, base mesh sub-bitstream, the displacements sub-bitstream and the attribute sub-bitstream to generate a single V3C Bitstream b(i). Thus, for each mesh frame, the V-DMC encoder creates a base mesh, which typically has a lesser number of vertices compared to the original mesh. The base mesh is compressed either in a lossy or lossless manner to create a base mesh sub-stream. The V-DMC encoder also generates the reconstructed base mesh.

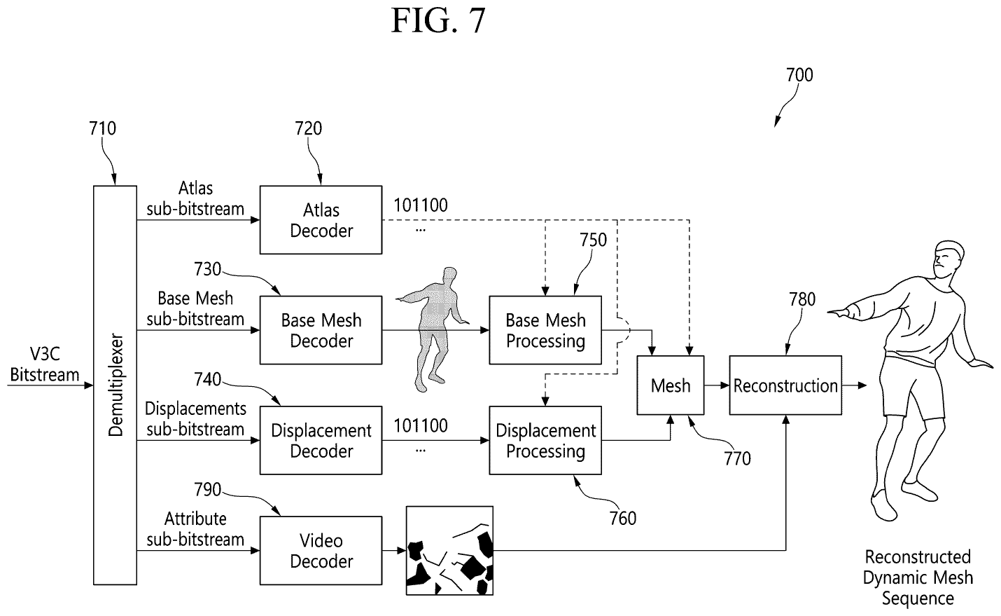

FIG. 7 shows a basic block diagram for a V-DMC decoder in accordance with an embodiment.

Referring to FIG. 7, the V-DMC decoder 700 in accordance with an embodiment includes a demultiplexer 710, an atlas decoder 720, a base mesh decoder 730, a displacement decoder 740, a base mesh processing unit 750, a displacement processing unit 760, a mesh processing unit 770 and a reconstruction processing unit 780. In some embodiments, the V-DMC decoder 700 may include a video decoder 790.

The demultiplexer 710 may separate the V3C Bitstream b(i) to generate the atlas sub-bitstream, the base mesh sub-bitstream, and the displacements sub-bitstream. In some embodiments, the demultiplexer 710 may further separate the V3C Bitstream b(i) to additionally generate the attribute sub-bitstream. The atlas decoder 720 may decode the atlas sub-bitstream to generate the atlas information. The base mesh decoder 730 may decode the base mesh sub-bitstream to generate the base mesh m(i). The displacement decoder 740 may decode the displacements sub-bitstream to generate the displacement d(i). In some embodiments, the video decoder 790 may decode the attribute sub-bitstream to generate the attribute A(i). The base mesh processor 750 may process the atlas information and the base mesh m(i) to generate a reconstructed base mesh m″(i). The displacement processor 760 may process the atlas information and the displacement d(i) to generate a reconstructed displacement matrix. The mesh processor 770 may process the atlas information, the reconstructed base mesh m″(i) and the reconstructed displacement matrix D″(i) to generate the reconstructed deformed mesh DM(i). In some embodiments, the reconstruction processing unit 780 may process the reconstructed deformed mesh DM(i) and the attribute A(i) to generate the reconstructed dynamic mesh sequence.

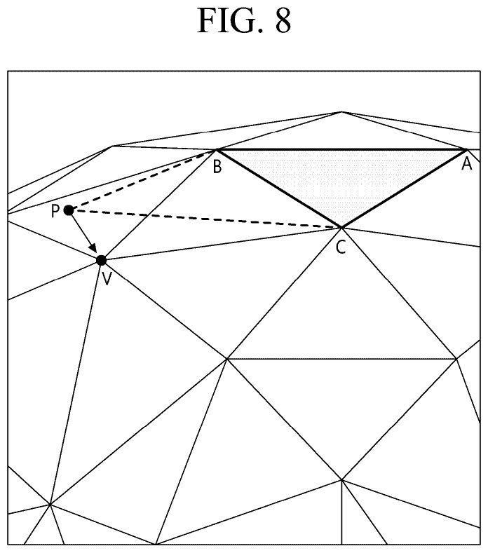

FIG. 8 shows an example of a parallelogram predictor.

Referring to FIG. 8, when intra coding is used, the vertex position (e.g. X, Y and Z geometric coordinates) in the base-mesh may be predicted from the positions of the available neighboring vertices. The vertex V is the vertex being predicted. The predictor P of the vertex V may be determined from the available neighboring vertices A, B and C. The parallelogram predictor P may be determined as expressed in Equation 1:

$$P = B + C - A . \qquad Equation 1$$

The geometry prediction error D may be transmitted. The geometry prediction error may be determined as expressed in Equation 2:

$$D = V - P . \qquad Equation 2$$

V, P, A, B and C all may have three components (e.g. X, Y, Z geometric coordinates).

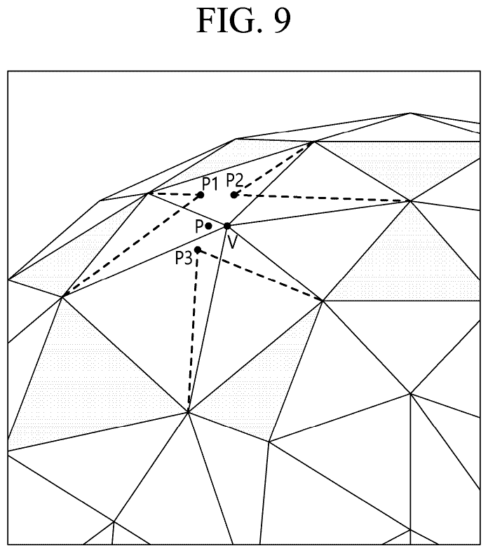

FIG. 9 shows an example of a multiple parallelogram predictor. In some embodiments, the predictors P1, P2 and P3 each may be determined from the positions of the vertices of three neighboring triangles (already transmitted) using parallelogram prediction as expressed in Equation 1. The final predictor P may be determined as an average of predictors P1, P2 and P3. The geometry prediction error is as expressed in Equation 2.

In some embodiments, other predictors may be used in place of parallelogram prediction, for example average value of available vertices may be used. A group of available vertices may comprise a previous vertex, a left vertex and/or a right vertex.

In some embodiments, like in V-DMC basemesh codec, the material properties (such as texture coordinates) may also be transmitted for each vertex. The texture coordinates map the vertex to a 2D position in the texture image which may then be for texture mapping while rendering the 3D object. The 2D position in the texture image may be indicated by (U, V) coordinates. The texture coordinates may be predicted from the texture coordinates and geometry coordinates of the neighboring available vertices. The prediction error (actual texture coordinate-predicted texture coordinate) may be determined and transmitted.

In some embodiments, the position predictor may be determined as a weighted average of multiple predictors, where the predictors used in determining the weighted average are determined using parallelogram prediction process as shown in Table 1.

```
TABLE 1
GEO_SHIFT = 5;
GEO_SCALE = (1 << GEO_SHIFT);
const int weight[MAX_PARALLELOGRAMS][MAX_PARALLELOGRAMS] = {
  {GEO_SCALE, 0, 0, 0}, // 1.0, 0, 0, 0
  {GEO_SCALE / 2, GEO_SCALE / 2, 0, 0}, // 0.5, 0.5, 0, 0
  {(GEO_SCALE+1) / 3, GEO_SCALE − 2 * (GEO_SCALE + 1) / 3, (GEO_SCALE + 1) / 3,
0}, // 1/3, 1/3, 1/3, 0 − approximation
  {GEO_SCALE/4, GEO_SCALE/4, GEO_SCALE/4, GEO_SCALE/4}, // 0.25, 0.25, 0.25,
0.25
};
pred = {0, 0, 0};
for (int i = 0; i < count; ++i) {
  Pred += weight[count − 1][i] * predPos[i];
}
pred = (pred + (GEO_SCALE / 2)) >> GEO_SHIFT;
```

Referring to Table 1, the final predictor pred is a 3D vector containing the x-coordinate, the y-coordinate and the z-coordinate. The i^{th} predictors are given in predPos[i] for the multiple parallelograms. The number of available predictors is given in count. Each of the predictors predPos[i] is a 3D vector containing the x-coordinate, the y-coordinate and the z-coordinate respectively.

In some embodiments, the weights may be selected as shown in weight [ ][ ] matrix in Table 1, where GEO_SHIFT is the number of fractional bits used in the fixed-point integer implementation of the position predictor and MAX_PARALLELOGRAMS is the maximum number of parallelogram predictors used to build the final predictor.

In some embodiments, the weights matrix may have other values than what is shown in Table 1 without loss of generality. The value of weights matrix may be a predetermined constant. The value of the matrix may be transmitted in the bitstream.

In some embodiments, a predictor for texture coordinate may be determined in fixed point as shown in the source code in Table 2.

```
TABLE 2
const int64_t UV_SHIFT = B
const int64_t UV_SCALE = (1L << UV_SHIFT);
{
  // accumulate uv predictions
  const glm::i64vec2 uvPrevI = UV coord of previous vertex in triangle; //fxp:0
  const glm::i64vec2 uvNextI = UV coord of next vertex in triangle; //fxp:0
  const glm::i64vec3 gPrevI = Geometry coord of previous vertex in triangle; //fxp:0
  const glm::i64vec3 gNextI = Geometry coord of next vertex in triangle; //fxp:0
  const glm::i64vec3 gCurrI = Geometry coord of current vertex in triangle; //fxp:0
  const glm::i64vec3 gNgPI = gPrevI − gNextI; // fxp:0
  const glm::i64vec3 gNgCI = gCurrI − gNextI; //fxp:0
  const glm::i64vec2 uvNuvPI = uvPrevI − uvNextI; //fxp:0
  int64_t gNgP_dot_gNgCI = gNgPI.x * gNgCI.x + gNgPI.y * gNgCI.y + gNgPI.z * gNgCI.z;
//fxp:0
  int64_t d2_gNgPI =gNgPI.x * gNgPI.x + gNgPI.y * gNgPI.y + gNgPI.z * gNgPI.z; //fxp:0
  if (d2_gNgPI > 0)
  {
    int64_t projRatioI = (UV_SCALE * gNgP_dot_gNgCI) / d2gNgPI; // fxp:uv_SHIFT
    glm::i64vec2 uvProjI = uvNextI * UV_SCALE + uvNuvPI *projRatioI;
//fxp:UV_SHIFT
    glm::i64vec3 gProjI = gNextI * UV_SCALE + gNgPI * projRatioI; //fxp:UV_SHIFT
    glm::i64vec3 gCgNI = gCurrI * UV_SCALE − gProjI; //fxp:UV_SHIFT
    int64_t d2_gProj_gCurrI = gCgNI.x * gCgNI.x + gCgNI.y * gCgNI.y + gCgNI.z
*gCgNI.z; //fxp:2*UV_SHIFT
    int64_t ratio = d2_gProj_gCurrI / d2_gNgPI //fxp:2*UV_SHIFT
    int64_t ratio_sqrt = isqrt(ratio << 2) >> 1; //fxp:UV_SHIFT
    glm::i64vec2 uvProjuvCurrI = glm::i64vec2(uvNuvPI.y, −uvNuvPI.x)
    uvProjuvCurrI = uvProjuvCurrI * ratio_sqrt; //fxp:UV_SHIFT
    glm::i64vec2 predUV0I(uvProjI + uvProjuvCurrI); //fxp:UV_SHIFT
    glm::i64vec2 predUV1I(uvProjI − uvProjuvCurrI); //fxp:UV_SHIFT
    // the first estimation for this UV corner
    bool useOpp = false;
    // we cannot use the opposite if beyond a seam
    const bool onSeam = check if the vertex is on a seam;
    // we cannot use the opposite if beyond a seam
    const bool checkOpposite = check if the vertex is beyond a seam;
    if (checkOpposite) {
      // check that 0 not aligned with N and P (possible to discriminate sides)
      const glm::i64vec2 uvOppI = UV coord of next vertex in triangle; // fxp:0
      // this test should be using 64b integers − this is (vecNP \hat{ } vec NO)
      const glm::i64vec2 NP = (uvPrevI − uvNextI); //fxp:0
      glm::i64vec2 NO(uvOppI − uvNextI); //fxp: 0
      // evaluate cross product
    }
    if (useOpp) {
      glm::i64vec2 uvOppI = UV coord of next vertex in triangle; //fxp:0
      uvOppI = uvOppI << UV_SHIFT; //fxp:0
      const auto OUV0I = uvOppI − predUV0I; //fxp:UV_SHIFT
      const auto OUV1I = uvOppI − predUV1I; //fxp:UV_SHIFT
      int64_t dotOUV0I = OUV0I.x * OUV0I.x + OUV0I.y * OUV0I.y;
//fxp:2*UV_SHIFT
      int64_t dotOUV1I = OUV1I.x * OUV1I.x + OUV1I.y * OUV1I.y;
//fxp:2*UV_SHIFT
      glm::i64vec2 predUVI = (dotOUV0I < dotOUV1I) ? predUV1I : predUV0I
      predUV = predUVI; // fxp:UV_SHIFT
    }
    else {
      //readOrientation( ) is the triangle orientation read from the bitstream
      const glm::i64vec2 predUVd1 = readOrientation( ) ? predUV0I : predUV1I; //
fxp:UV_SHIFT
      predUV = predUVdI; //fxp:uv_SHIFT
    }
  }
  // else average the two predictions
  Else
  {
    predUV = UV coord of previous vertex in triangle + UV coord of previous vertex in
triangle; // fxp:1
    // multipy by UV_SCALE/2 instead of UV_SCALE to account for fxp:1 of previous line
    predUV = predUV * glm::i64vec2(UV_SCALE/2); // fxp:UV_SHIFT
  }
}
```

Referring to Table 2, the vector uvPrevI is a two-dimensional (2D) vector that represents the texture coordinate of the previous vertex in a triangle with the current vertex (the triangle). The vector uvNextI is a 2D vector that represents the texture coordinate of the next vertex in the triangle. The vector gPrevI is a three-dimensional (3D) vector that represents the geometry coordinate of the previous vertex in the triangle. The vector gNextI is a 3D vector that represents the geometry coordinate of the next vertex in the triangle. The vector gCurrI is a 3D vector that represents the geometry coordinate of the current vertex in the triangle. The vector gNgPI is a 3D vector that represents the difference between the geometry coordinate of the previous vertex in a triangle with the current vertex and the geometry coordinate of the next vertex in the triangle. The vector gNgCI is a 3D vector that represents the difference between the geometry coordinate of the current vertex in the triangle and the geometry coordinate of the next vertex in the triangle. The vector uvNuvPI is a 2D vector that represents the difference between the texture coordinate of the previous vertex in the triangle and the texture coordinate of the next vertex in the triangle. The variable gNgP_dot_gNgCI is an integer that represents the dot product of the vector gNgPI and the vector gNgCI. The d2_gNgPI is an integer that represents the dot product of the vector gNgPI and the vector gNgPI, or the vector gNgPI squared. In some embodiments, the 3D vectors described above may comprise a x-coordinate, a y-coordinate and a z-coordinate. In some embodiments, the 2D vectors described above may comprise a x-coordinate and a y-coordinate.

In Table 2, the vectors uvPrevI, uvNextI, gPrevI, gNextI, gCurrI, gNgPI, gNgCI, and uvNuvPI, and variables gNg_dot_gNgCI and d2_gNgPI are determined based on the relevant descriptions above.

Further referring to Table 2, the variable projRatioI is an integer that represents a projection ratio to be used in determining the predicted texture coordinate for the current vertex. The variable projRatioI is represented as the product of a scaling factor UV_SCALE for texture coordinates and the variable gNgP_dot_gNgCI, then divided by the variable d2gNgPI. The vector uvProjI is a 2D vector that represents a projected texture coordinate of the next vertex in the triangle determined by the sum of a first product of the vector uvNextI and the scaling factor UV_SCALE, and a second product of the vector uvNuvPI and the variable projRatioI. The vector gProjI is a 3D vector that represents a projected geometry coordinate determined by the sum of a first product of the vector gNextI and the variable UV_SCALE and a second product of the vector gNgPI and the variable projRatioI. The vector gCgNI is a 3D vector that represents the difference between the product of the vector gCurrI and the variable UV_SCALE and the vector gProjI. The variable d2_gProj_gCurrI is an integer that represents the dot product the vector gCgNI and the vector gCgNI, or the vector gCgNI squared. The ratio is an integer that represents the division of the dot product of the product described above for the variable d2_gProj_gCurrI by the dot product described above for the variable d2_gNgPI. The variable ratio_sqrt is the square root of the ratio determined by shifting to the right the results of square root function, isqrt( ) with the input of the ratio shifted to the left twice. The vector uvProjuvCurrI is a 2D vector that represents a projected texture coordinate of the current vertex determined as a 2D vector where the x-coordinate is the y-coordinate uvNuvPI.y and the y-coordinate is the negative of the x-coordinate uvNuvPI.x. The predUV0I is a 2D vector that represents a first predicted texture coordinate for the current vertex in the triangle determined by the sum of the vector uvProjI and the vector uvProjuvCurrI. The predUVII is a 2D vector that represents a second predicted texture coordinate of the current vertex in the triangle determined by the difference between the vector uvProjI and the vector uvProjuvCurrI.

In Table 2, if the d2_gNgPI is a positive integer then the projRatioI, the uvProjI, the gProjI, the gCgNI, the d2_gProj_gCurrI, the ratio and the ratio_sqrt are determined based on the relevant descriptions above. Subsequently, the uvProjuvCurrI is then further determined based on the result of the product of the uvProjuvCurrI and the ratio_sqrt. The predUV0I and the predUVII are then determined.

Referring to Table 2, the variable useOpp is a boolean that represents whether or not the opposite vertex may be used. The variable onSeam is a boolean that represents whether or not the vertex is on a scam. The variable checkOpposite is a boolean that represents whether or not the vertex is beyond the seam. The vector uvOppI is a 2D vector that represents the texture coordinate of the next vertex in the triangle. The vector NP is a 2D vector that represents the difference between the vector uvPrevI and uvNextI. The vector NO is a 2D vector that represent the difference between the vector uvOppI and the vector uvNextI. The vector OUVOI is a 2D vector that represents the difference between the vector uvOppI and the vector predUV0I. The vector OUVII is a 2D vector that represents the difference between the vector uvOppI and the vector predUVII. The variable dotOUV0I is an integer that represents the the vector OUVOI squared. The variable dotOUVII is an integer that represents the vector OUVII squared. The vector predUVI is a 2D vector that represents the final predicted texture coordinate of the current vertex in the triangle determined to be the vector predUVII if the variable dotOUV0I is less than the variable dotOUVII or otherwise is determined to be the vector predUV0I. The vector predUV is a 2D vector that represents the predicted texture coordinate that Table 2 results in. The vector predUVdI is a 2D vector that represents the final predicted texture coordinate determined to be either the vector predUV0I or the vector predUVII based on the orientation of the triangle.

In Table 2, the vertex predUVI may be determined based on the opposite vertex. If the opposite vertex in the triangle may be used, then the vertex predUVI may be the vector predUV0I or the vector predUVII based on whether the variable dotpredUV0I is greater than the variable dotpredUVII. If the opposite vertex in the triangle may not be used then the vertex predUVI may be the vector predUV0I or the vector predUVII based on the orientation of the triangle. If the dot product of the difference between the geometric coordinate gNextI and the geometric coordinate gPrevI is not positive, then the predicted texture coordinate may be determined as the average of the vector predUV0I and the vector predUVII.

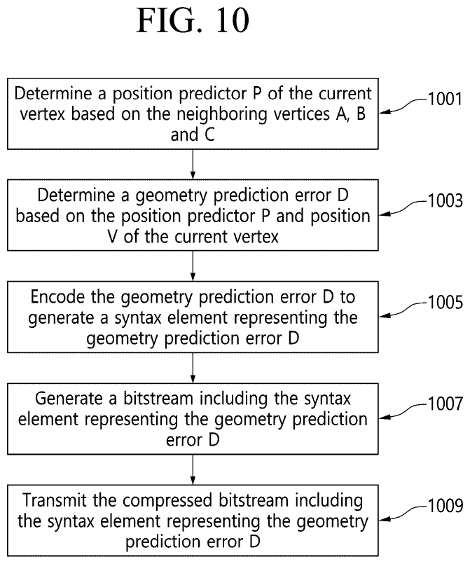

FIG. 10 is a flowchart showing operations of the V-DMC encoder 400 for geometry coordinate prediction in accordance with an embodiment.

Referring to FIG. 10, the V-DMC encoder 400 encodes a geometric position prediction error.

At 1001, the V-DMC encoder 400 determines a position predictor P of the current vertex based on the neighboring vertices A, B and C. The position predictor P is determined as the difference between the sum of vertices B and C and the vertex A. In some embodiments, the position predictor P is instead determined using multiple parallelogram predictors where P is determined as the average of the multiple parallelogram predictors. The V-DMC encoder 400 determines a multiple parallelogram predictor Pᵢ based on the neighboring vertices Aᵢ, Bᵢ and Cᵢ as described above.

At 1003, the V-DMC encoder 400 determines a geometry prediction error D based on the position predictor P and position V of the current vertex. The geometry prediction error D is determined as the difference between position V of the current vertex and the position predictor P.

At 1005, the V-DMC encoder 400 encodes the geometry prediction error D to generate a syntax element representing the geometry prediction error D.

At 1007, the V-DMC encoder 400 generates a bitstream including the syntax element representing the geometry prediction error D.

At 1009, the V-DMC encoder 400 transmits the compressed bitstream including the syntax element representing the geometry prediction error D.

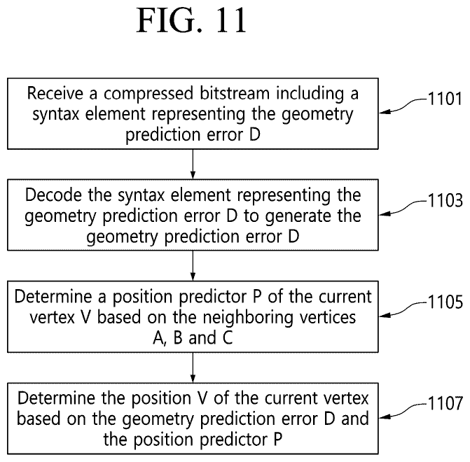

FIG. 11 is a flowchart showing operations of the V-DMC decoder 500 for geometry coordinate prediction in accordance with an embodiment

Referring to FIG. 11, the V-DMC decoder 500 decodes a position V of the current vertex.

At 1101, the V-DMC decoder 500 receives a compressed bitstream including a syntax element representing the geometry prediction error D.

At 1103, the V-DMC decoder 500 decodes the syntax element representing the geometry prediction error D to generate the geometry prediction error D.

At 1105, the V-DMC decoder 500 determines a position predictor P of the current vertex V based on the neighboring vertices A, B and C as described at 1001 in FIG. 10.

At 1107, the V-DMC decoder 500 determines the position V of the current vertex based on the geometry prediction error D and the position predictor P. The position V of the current vertex is determined as the sum of the geometry prediction error D and the position predictor P.

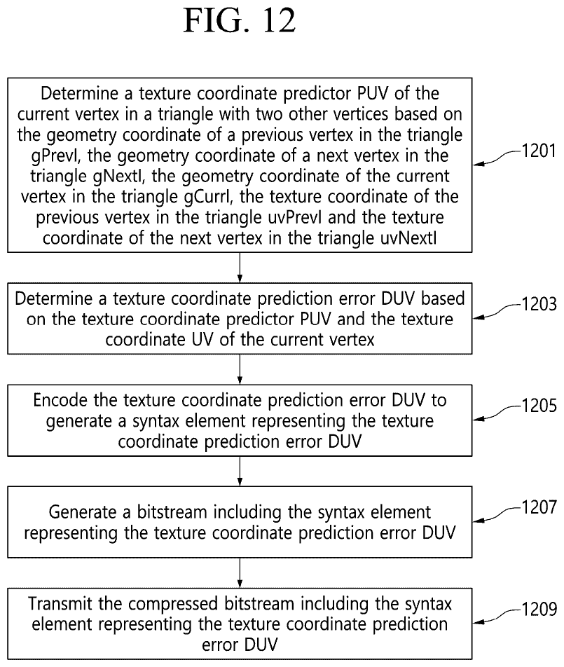

FIG. 12 is a flowchart showing operations of the V-DMC encoder 400 for texture coordinate prediction in accordance with an embodiment.

Referring to FIG. 12, the V-DMC encoder 400 encodes a texture coordinate prediction error.

At 1201, the V-DMC encoder 400 determines a texture coordinate predictor PUV, represented as predUV in Table 2, of the current vertex in a triangle with two other vertices based on the geometry coordinate gPrevI of a previous vertex in the triangle, the geometry coordinate gNextI of a next vertex in the triangle, the geometry coordinate gCurrI of the current vertex in the triangle, the texture coordinate uvPrevI of the previous vertex in the triangle and the texture coordinate uvNextI of the next vertex in the triangle, as shown in Table 2. In some embodiments, the PUV may be determined by a combination of the operations represented in Table 2.

At 1203, the V-DMC encoder 400 determines the texture coordinate prediction error DUV based on the texture coordinate predictor PUV and the texture coordinate UV of the current vertex. In some embodiments, the texture coordinate prediction error DUV may be determined as the difference between the texture coordinate predictor PUV and the texture coordinate UV of the current vertex.

At 1205, the V-DMC encoder 400 encodes the texture coordinate prediction error DUV to generate a syntax element representing the texture coordinate prediction error DUV.

At 1207, the V-DMC encoder 400 generates a bitstream including the syntax element representing the texture coordinate prediction error DUV.

At 1209, the V-DMC encoder 400 transmits the compressed bitstream including the syntax element representing the texture coordinate prediction error DUV.

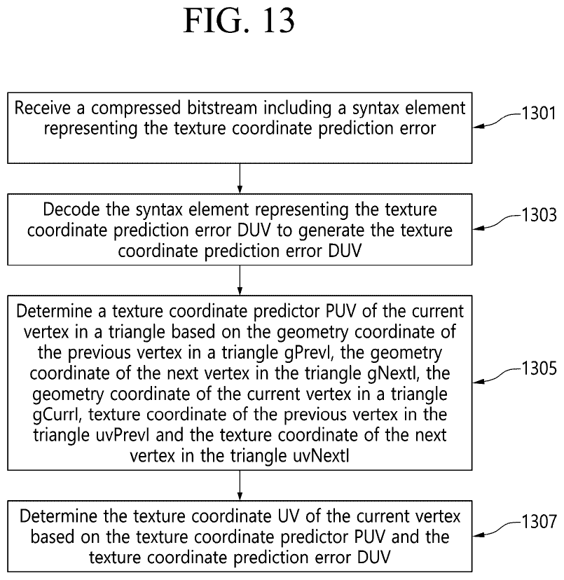

FIG. 13 is a flowchart showing the operations of the V-DMC decoder 500 for texture coordinate prediction in accordance with an embodiment.

Referring to FIG. 13, the V-DMC decoder 500 decodes a bitstream to generate a texture coordinate of the current vertex in a triangle.

At 1301, the V-DMC decoder 500 receives a compressed bitstream including a syntax element representing the texture coordinate prediction error.

At 1303, the V-DMC decoder 500 decodes the syntax element representing the texture coordinate prediction error DUV to generate the texture coordinate prediction error DUV.

At 1305, the V-DMC decoder 500 determines a texture coordinate predictor PUV of the current vertex in a triangle based on the geometry coordinate of the previous vertex in the triangle gPrevI, the geometry coordinate of the next vertex in the triangle gNextI, the geometry coordinate of the current vertex in the triangle gCurrI, the texture coordinate of the previous vertex in the triangle uvPrevI and the texture coordinate of the next vertex in the triangle uvNextI.

At 1307, the V-DMC decoder 500 determines the texture coordinate UV of the current vertex based on the texture coordinate predictor PUV and the texture coordinate prediction error DUV. In some embodiments, the texture coordinate UV may be determined as the sum of the texture coordinate predictor PUV and the texture coordinate prediction error DUV.

The various illustrative blocks, units, modules, components, methods, operations, instructions, items, and algorithms may be implemented or performed with processing circuitry.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the subject technology. The term “exemplary” is used to mean serving as an example or illustration. To the extent that the term “include,” “have,” “carry,” “contain,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, the description may provide illustrative examples and the various features may be grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The embodiments are provided solely as examples for understanding the invention. They are not intended and are not to be construed as limiting the scope of this invention in any manner. Although certain embodiments and examples have been provided, it will be apparent to those skilled in the art based on the disclosures herein that changes in the embodiments and examples shown may be made without departing from the scope of this invention.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. An apparatus comprising:
a communication interface configured to receive a compressed bitstream comprising a base mesh sub-bitstream and a syntax element; and
a processor operably coupled to the communication interface, the processor configured to:
decode the syntax element to generate a first prediction error for a geometric coordinate of a current vertex;
determine a geometric coordinate of a first neighboring vertex of the current vertex based on the base mesh sub-bitstream;
determine a first predictor for the current vertex based on the geometric coordinate of the first neighboring vertex of the current vertex; and
determine a coordinate of the current vertex based on the first predictor and the first prediction error.

2. The apparatus of claim 1, wherein the processor is further configured to:
determine a geometric coordinate of a second neighboring vertex of the current vertex based on the base mesh sub-bitstream; and
determine the first predictor for the current vertex based on the geometric coordinate of the first neighboring vertex of the current vertex and the geometric coordinate of the second neighboring vertex of the current vertex.

3. The apparatus of claim 1, wherein the processor is further configured to:
determine a geometric coordinate of a second neighboring vertex of the current vertex based on the base mesh sub-bitstream; and
determine a second predictor based on the geometric coordinate of the second neighboring vertex,
wherein determining the current vertex comprises:
determining a final predictor based on the first predictor and the second predictor, and
determining the current vertex based on the final predictor and the first prediction error.

4. The apparatus of claim 3, wherein the final predictor is determined by applying a first predetermined weight to the first predictor and applying a second predetermined weight to the second predictor.

5. The apparatus of claim 4, wherein the first and second predetermined weights have values so that the final predictor is a weighted average of the first predictor and the second predictor.

6. The apparatus of claim 1, wherein the processor is further configured to:
determine a second prediction error for a texture coordinate of the current vertex;
determine a texture coordinate of the first neighboring vertex;
determine a predictor for the texture coordinate of the current vertex based on the texture coordinate of the first neighboring vertex; and
determine the texture coordinate for the current vertex based on the predictor for the texture coordinate of the current vertex and the second prediction error for the texture coordinate of the current vertex.

7. The apparatus of claim 6, wherein the processor is further configured to:
determine a texture coordinate of a second neighboring vertex; and
determine a predictor for the texture coordinate of the current vertex based on the texture coordinate of the first neighboring vertex and the texture coordinate of the second neighboring vertex.

8. The apparatus of claim 6, wherein the predictor for the texture coordinate of the current vertex is determined based on the texture coordinate of the first neighboring vertex, the geometric coordinate of the first neighboring vertex, and the geometric coordinate of the current vertex.

9. A method comprising:
receiving a compressed bitstream comprising a base mesh sub-bitstream and a syntax element;
decoding the syntax element to generate a first prediction error for a geometric coordinate of a current vertex;
determining a geometric coordinate of a first neighboring vertex of the current vertex based on the base mesh sub-bitstream;
determining a first predictor for the current vertex based on the geometric coordinate of the first neighboring vertex of the current vertex; and
determining a geometric coordinate of the current vertex based on the first predictor and the first prediction error.

10. The method of claim 9, further comprising:
determining a geometric coordinate of a second neighboring vertex of the current vertex based on the base mesh sub-bitstream; and
determining the first predictor for the current vertex based on the geometric coordinate of the first neighboring vertex of the current vertex and the geometric coordinate of the second neighboring vertex of the current vertex.

11. The method of claim 9, further comprising:
determining a geometric coordinate of a second neighboring vertex of the current vertex based on the base mesh sub-bitstream; and
determining a second predictor based on the geometric coordinate of the second neighboring vertex,
wherein determining the current vertex comprises:
determining a final predictor based on the first predictor and the second predictor, and
determining the current vertex based on the final predictor and the first prediction error.

12. The method of claim 11, wherein the final predictor is determined by applying a first predetermined weight to the first predictor and applying a second predetermined weight to the second predictor.

13. The method of claim 12, wherein the first and second predetermined weights have values so that the final predictor is a weighted average of the first predictor and the second predictor.

14. The method of claim 9, further comprising:
determining a second prediction error for a texture coordinate of the current vertex;
determining a texture coordinate of the first neighboring vertex;
determining a predictor for the texture coordinate of the current vertex based on the texture coordinate of the first neighboring vertex; and
determining the texture coordinate for the current vertex based on the predictor for the texture coordinate of the current vertex and the second prediction error for the texture coordinate of the current vertex.

15. The method of claim 14, further comprising:
determining a texture coordinate of a second neighboring vertex; and
determining a predictor for the texture coordinate of the current vertex based on the texture coordinate of the first neighboring vertex and the texture coordinate of the second neighboring vertex.

16. The method of claim 14, wherein the predictor for the texture coordinate of the current vertex is determined based on the texture coordinate of the first neighboring vertex, the geometric coordinate of the first neighboring vertex, and the geometric coordinate of the current vertex.

17. An apparatus comprising:
a communication interface; and
a processor operably coupled to the communication interface; the processor configured to:
determine a first vertex on a mesh frame;
determine a geometric coordinate of a first neighboring vertex of the first vertex;
generate a predictor based on the geometric coordinate of the first neighboring vertex;
determine a first prediction error based on the first vertex and the predictor;
generate a base mesh frame based on the mesh frame;
encode the base mesh frame and the first prediction error to generate a compressed bitstream; and
transmit the compressed bitstream.

18. The apparatus of claim 17, wherein the processor is further configured to:
determine a geometric coordinate of a second neighboring vertex of the first vertex; and
generate a predictor based on the geometric coordinate of the first neighboring vertex and the geometric coordinate of the second neighboring vertex.

19. The apparatus of claim 17, wherein the processor is further configured to:
determine a texture coordinate for the first vertex;
determine a texture coordinate of the first neighboring vertex;
generate a texture coordinate for a predictor based on the texture coordinate of the first neighboring vertex;
determine a second prediction error based on the texture coordinates of the first vertex and the texture coordinates of the predictor;
encode the base mesh frame and the second prediction error to generate a compressed bitstream; and
transmit the compressed bitstream.

20. The apparatus of claim 19, wherein the processor is further configured to:
determine a texture coordinate of a second neighboring vertex; and
generate a texture coordinate for a predictor based on the texture coordinate of the first neighboring vertex and the texture coordinate of the second neighboring vertex.
